(19) United States
(12) Patent Application Publication
(10) Pub. No.: US 2015/0333355 A1
(43) Pub. Date: Nov. 19, 2015

(54) FUEL CELL STACK ASSEMBLY AND METHOD OF ASSEMBLY

(71) Applicant: INTELLIGENT ENERGY LIMITED, Loughborough (GB)

(72) Inventors: Mark Phillip HORLOCK, Loughborough, Leicestershire (GB); Simon PAYNE, Loughborough, Leicestershire (GB); Andrew Paul KELLY, Loughborough, Leicestershire (GB)

(21) Appl. No.: 14/653,236

(22) PCT Filed: Dec. 17, 2013
(86) PCT No.: PCT/GB2013/053324

§ 371 Date: Jun. 17, 2015

(30) Foreign Application Priority Data
Dec. 21, 2012 (GB) 1223307.8

(51) Int. Cl. H01M 8/24; H01M 8/02

(52) U.S. Cl. CPC H01M 8/247; H01M 8/02

(57) ABSTRACT

A fuel cell stack assembly (200) comprising: a first encapsulation member (202) comprising a first end plate (204) and two side walls (208) extending transversely from the first end plate (204); a second encapsulation member (204) comprising a second end plate (205); and one or more fuel cells located between the first end plate (206) and second end plate (205), wherein the side walls (208) of the first encapsulation member (202) are, or the second encapsulation member (204) is, deformable in order for the first encapsulation member (202) to engage with the second encapsulation member (204) and retain the first end plate (206) and the second end plate (205) in a fixed relative position.

The present disclosure relates to fuel cell stack assemblies, and methods of assembling fuel cell stack assemblies.

Conventional electrochemical fuel cells convert fuel and oxidant, generally both in the form of gaseous streams, into electrical energy and a reaction product. A common type of electrochemical fuel cell for reacting hydrogen and oxygen comprises a polymeric ion (proton) transfer membrane, with fuel and air being passed over respective sides of the membrane. Protons (that is, hydrogen ions) are conducted through the membrane, balanced by electrons conducted through a circuit connecting the anode and cathode of the fuel cell. To increase the available voltage, a stack may be formed comprising a number of such membranes arranged with separate anode and cathode fluid flow paths. Such a stack is typically in the form of a block comprising numerous individual fuel cell plates held together by end plates at either end of the stack.

In accordance with a first aspect of the invention there is provided a fuel cell stack assembly comprising:
a first encapsulation member comprising a first end plate and two side walls extending transversely from the first end plate;
a second encapsulation member comprising a second end plate; and
one or more fuel cells located between the first end plate and second end plate,
wherein the side walls of the first encapsulation member are, or the second encapsulation member is, deformable in order for the first encapsulation member to engage with the second encapsulation member and retain the first end plate and the second end plate in a fixed relative position.

The side walls of the first encapsulation member or the second encapsulation member may be deformable in order to provide a compression force to the one or more fuel cells.

The side walls may each comprise a projection that extends away from the first end plate. The projection may be deformable such that it engages with the second encapsulation member in order to retain the first end plate and the second end plate in a fixed relative position, and optionally to provide a compression force to the one or more fuel cells.

The second encapsulation member may comprise two apertures, one for receiving each of the projections. The projections may be deformable in order to engage with an internal face of the second encapsulation member that defines the aperture.

The projections may be configured to extend into and through the apertures. The projections may be deformable in order to engage with an external face of the second encapsulation member.

The first end plate and the second end plate may each define a compression surface adjacent to, and in compressive relationship with, the one or more fuel cells. The first end plate and/or the second end plate may comprise a preformed element defining the compression surface. The preformed element may be configured with a predetermined curvature such that the compression surface is a convex surface when the preformed element is not under load whereas, under the application of the load to maintain the fuel cells under compression, flexure of the preformed element may cause the compression surface to become a substantially planar surface.

The first end plate and/or the second end plate may comprise a port for communicating a fluid, which may be a liquid or a gas, to or from the one or more fuel cells.

The fuel cell stack assembly may further comprise a build frame that is shaped for providing an assembly guide for at least one of: the first encapsulation member; the second encapsulation member; and the one or more fuel cells.

The assembly guide may be orientation specific such that components cannot be inserted into the build frame in an incorrect orientation. The assembly guide may comprise asymmetrical guide rails. At least one of the first encapsulation member, the second encapsulation member, and the one or more fuel cells may comprise corresponding asymmetrical shoulders.

Both the second encapsulation member and the side walls of the first encapsulation member may be deformable.

The second encapsulation member may comprise two side walls extending transversely from the second end plate. The side walls of the second encapsulation member may be deformable in order to engage with the side walls of the first encapsulation member.

One or both of the side walls of the second encapsulation member may be within, outside, or co-planar with the side walls of the first encapsulation member. The side walls of the first encapsulation member may be parallel to the side walls of the second encapsulation member.

According a further aspect of the invention, there is provided a method of assembling a fuel cell stack assembly, the fuel cell stack assembly comprising:
a first encapsulation member comprising a first end plate and two side walls extending transversely from the first end plate;
a second encapsulation member comprising a second end plate; and
one or more fuel cells;
   the method comprising:
locating the one or more fuel cells between the first end plate and the second end plate;
applying an external load to bias the first end plate of the first encapsulation member and the second end plate of the second encapsulation member towards one another thereby compressing the one or more fuel cells;
deforming the side walls of the first encapsulation member or the second encapsulation member in order for the first encapsulation member to engage with the second encapsulation member ; and
releasing the external load, thereby providing a fuel cell stack assembly that exerts a compression force on the one or more fuel cells and retains the first end plate and the second end plate in a fixed relative position.

A description is now given, by way of example only, with reference to the accompanying drawings, in which:

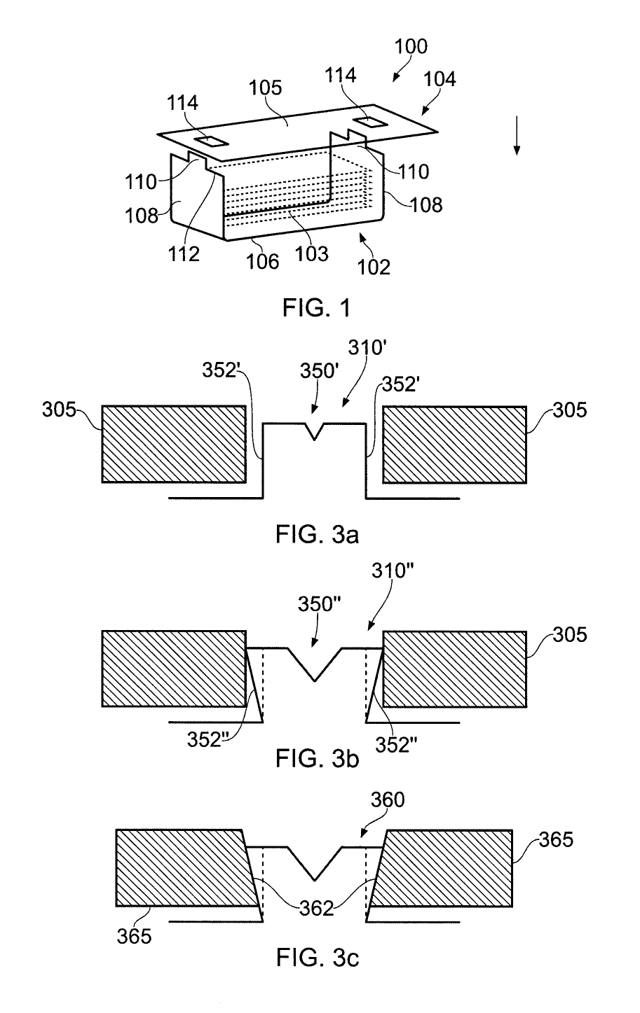

FIG. 1 illustrates a fuel cell stack assembly;

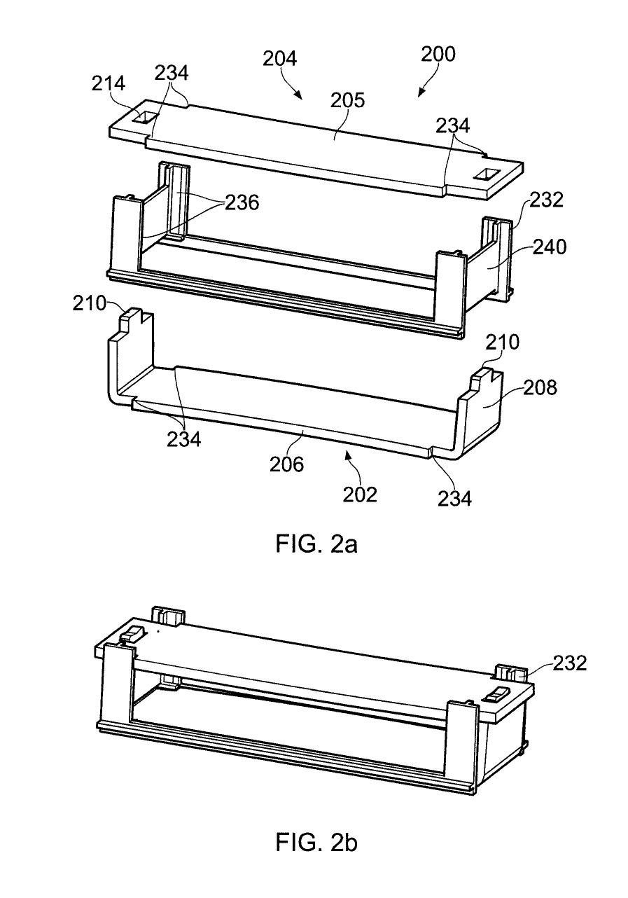

FIG. 2a illustrates an exploded perspective view of another fuel cell stack assembly;

FIG. 2b illustrates a view of the fuel cell stack assembly of FIG. 2a when assembled;

FIG. 3a shows an end view of a tab in an un-splayed configuration in an opening in a second end plate;

FIG. 3b shows an end view of the tab of FIG. 3a in a splayed configuration when it is engaged with the second end plate;

FIG. 3c shows an end view of another tab in a splayed configuration in an opening in a second end plate; and

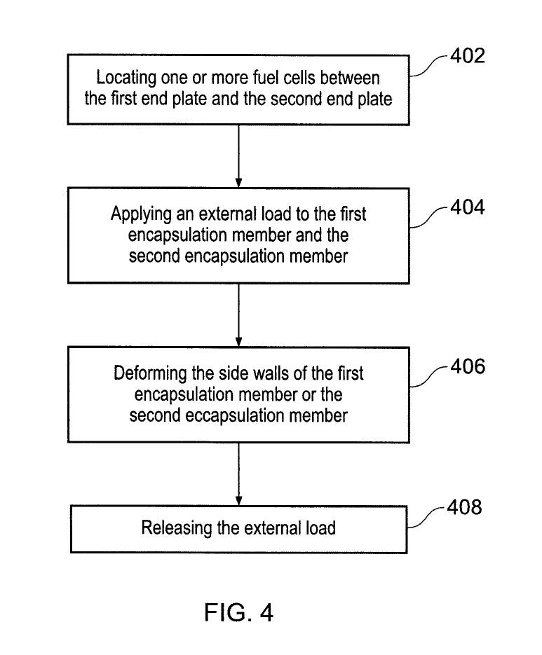

FIG. 4 illustrates a method of assembling a fuel cell stack assembly.

FIG. 1 illustrates a fuel cell stack assembly 100 comprising a first encapsulation member 102 and a second encapsulation member 104 that are configured to engage with each other in order to retain the first end plate and the second end plate in a fixed relative position and optionally to apply a compression force to one or more fuel cells 103 located between the two encapsulation members 102, 104.

The first encapsulation member 102 comprises a first end plate 106 and two side walls 108 that extend transversely from, and at opposing ends of, the first end plate 106. The second encapsulation member 104 comprises a second end plate 105.

Each of the side walls 108 has a tab 110 extending away from its distal end (the end furthest from the first end pate 106). The tabs 110 are examples of projections that are deformable in order to engage with the second encapsulation member 104. Each tab 110 has a width that is less than a region of the associated side wall 108 that is closer than that tab 110 to the first end plate 106.

In this example, two shoulders 112 are defined in the side walls 108 at the transition between the tabs 110 and the adjacent part of the side wall 108. The shoulders 112 represent a step change in the width of the side walls 108, which can be used to assist with engaging the second encapsulation member 104 with the first encapsulation member 102. It will be appreciated that the shoulders 112 are optional in some examples.

The second end plate 106 has two apertures 114 that are configured to receive the tabs 110 of the first encapsulation member 102 when the fuel cell assembly 100 is assembled. The size of the apertures 114 is similar to, but slightly larger than, the cross-sectional size of the tab 110 in a plane that is parallel to the plane of the fuel cells 103. For example a clearance of only a few millimetres may be provided so that the tabs 110 can be inserted into the apertures 114 during assembly.

The second end plate 105 is shown positioned over, but not engaged with, the tabs 110 in FIG. 1. In order for the first encapsulation member 102 to engage with the second encapsulation member 104, the second encapsulation member 104 is moved towards the first encapsulation member 102 under the action of an external load. In the illustration of FIG. 1, the external load causes the second encapsulation member 104 to move downwards. The first and second encapsulation members 102, 104 are biased towards each other until the fuel cells 103 are compressed to a working dimension or to a working load such that gaskets and seals associated with the fuel cells 103 can function correctly.

The first and second encapsulation members 102, 104 are then engaged together by deforming the tabs 110 such that they contact the second encapsulation member 104 in order to retain the first encapsulation member 102 and the second encapsulation member 104 in a fixed relative position. In this way, a compression force is applied to the fuel cells 103 in a direction that is normal to the plane of the fuel cells 103. The compressed fuel cells 103 exert an expansive force on the first and second end plates 106, 105 of the respective first and second encapsulation members 102, 104. The engagement between the tabs 110 and the second encapsulation member 104 resists the expansive force of the compressed fuel cells 103 when the external load is removed.

The tabs 110 can be deformed such that they engage with a face of the second encapsulation member 104 that defines the aperture 114. That is, a face that is internal to the footprint of the second encapsulation member 104. The walls of the second encapsulation member 104 that define the aperture 114 may be orthogonal to the plane of the fuel cells 103. In this way, friction between the tabs 110 and one or more of the faces of the second encapsulation member 104 can be provided that it is sufficient to retain engagement between the first and second encapsulation members 102, 104 and so maintain the fuel cells 103 in compression.

In another example, the tabs 110 can extend into and through the apertures 114 such that they extend beyond a top surface of the second encapsulation member 104, which is an example of an external face of the second encapsulation member 104. The tabs 110 can then be deformed such that they engage with the top surface of the second encapsulation member 104. In this way, the deformed tabs 110 can provide a barrier to the second encapsulation member 104 moving away from the first end plate 106 under the expansive force of the compressed fuel cells 103.

When the fuel cells are stationary and held between the first end plate 106 and second end plate 105 under a compressive force, they provide a force pushing outwards on the two end plates 105, 106. The two end plates 105, 106 are retained in position relative to each other due to the deformation of the tabs 110 of the first encapsulation member 102. In other examples, it will be appreciated that any part of one or both of the first and second encapsulation members 102, 104 may be deformed in order to provide the necessary resistance to the expansion of the fuel cells 103, thereby maintaining the first end plate 106 stationary relative to the second end plate 105 and so keeping the fuel cells 103 under compression.

In some examples, the fuel cell stack assembly can be “built to load” such that the two encapsulation members 102, 104 are brought together until a desired loading force is applied to the fuel cells 103, which in some examples can be considered better than building a fuel cell stack assembly to a specific dimension. As applications for smaller fuel cell stacks become increasingly important, materials with a thinner gauge become particularly advantageous. However, if a fuel cell assembly is built to a set height, an overload may need to be applied to ensure that a sufficient compression force is applied to the fuel cells for all variations of the fuel cell dimensions that are within the tolerances of construction. Such overloading can cause buckling of thin components thereby compromising performance of the fuel cell stack. Therefore, fuel cell assemblies disclosed herein that can be built to a predetermined load instead of a predetermined height can reduce these problems.

In other applications, however, building to a desired dimension can be acceptable. In which case, the second encapsulation member 104 can be moved towards the first encapsulation member 102 until it abuts the shoulders 112 of the side walls 108, thereby compressing the fuel cells 103 to a desired dimension.

Providing a fuel cell assembly that uses deformation of one of the encapsulation members to retain the fuel cells in compression can provide one more of the following advantages:
a small area of contact to hold the assembly in place;
the expansion force of the fuel cells can be used to maintain engagement of the first and second encapsulation members 102, 104, which can reduce the likelihood of loosening over time;
a fine controlled level of compression can be maintained as the deformation can act at any point time during the compression that is applied during assembly;
little or no over-compression may be required to assemble the fuel cell stack assembly. This is in contrast to other methods of assembly, whereby the external force applied to the end plates 102, 104 causes required compression level to be exceeded during assembly and then reduced to the level required for use of the fuel cell stack assembly. Embodiments disclosed herein can allow the compression applied to the fuel cells to be locked/fixed when it is achieved during assembly, thereby avoiding significant or any over-compression;
reduced variability in implementation of the fuel cell assembly compared with assemblies that use a spring clip, as the engagement between the encapsulation members may not exert any force; it just resist the expansive force that is exerted on it.
This method may be used for both locking the end plates in a fixed relative position and also for applying a compression force as the two plates are pulled together and the end plates are deformed.

The construction of such a fuel cell assembly may therefore be simplified as the end plates may be simply slid into place and a simple deformation performed. Also, the overall addition to the size of the assembly is small.

It will be appreciated that in other examples the first encapsulation member may comprise side walls with tabs that extend from more than two edges, or in some cases all edges, of the first end plate. In such examples, corresponding apertures may be provided in the second encapsulation member.

FIGS. 2a and 2b illustrate another fuel cell stack assembly 200. FIG. 2a shows an exploded perspective view of the fuel cell stack assembly 200. FIG. 2b shows a view of the fuel cell stack assembly 200 when it is assembled.

The fuel cell stack assembly 200 includes a first encapsulation member 202 and a second encapsulation member 204. As discussed above, fuel cells will be compressed between the two encapsulation members 202, 204, although the fuel cells are not shown in FIG. 2. The fuel cell stack assembly 200 also includes a build frame 232, which can be internally shaped for providing an assembly guide for at least some of the components of the fuel cell assembly 200. Features of the fuel cell stack assembly 200 that have already been described with reference to FIG. 1 will not necessarily be described again here.

In this example, the first encapsulation member 202 is located at a build point and the build frame 232 is located on top of the first encapsulation member 202. The side walls 208 of the first encapsulation member 202 are located on the outside of the build frame 232 such that the build frame 232 can provide a guide for locating the fuel cells and or second encapsulation member 204. External faces of the build frame 232 can provide a guide for correctly locating the first encapsulation member 202 relative to the build frame 232. The guide frame 232 is integral with the assembled fuel cell stack assembly 200, as shown in FIG. 2b.

The fuel cells are then located on top of the first encapsulation member 202 and the build frame 232. The build frame 232 may have side walls 240 that have a friction contact with the fuel cells, which can help to retain the fuel cells in a partially compressed position. In examples of the build frame 232 that do not have a guide, the friction contact can also assist with properly locating the fuel cells. This can make this stage of the assembly easy and robust to handle without parts moving or falling out.

The build frame 232 can have one or more known guide mechanisms or members that engage with an edge or face of the fuel cells, second end plate 205, or any other known component of a fuel cell stack, to locate them in a desired position. For example, guide rails may be provided. The guide mechanisms or members may also be orientation specific such that components cannot be inserted into the build frame 232 in an incorrect orientation, such as upside down. One such implementation of an orientation-specific guide mechanism is shown in FIG. 2a by the asymmetrical shoulders 234 that are provided on the first and second end plates 206, 205. These asymmetrical shoulders 234 engage with corresponding asymmetrical guide rails 236 in the build frame 232.

After the second encapsulation member 204 and fuel cells have been inserted into the build frame 232, the first and second encapsulation members 202, 204 are compressed to a working dimension or to a working load such that gaskets and seals associated with the fuel cells can function correctly. As discussed above, this causes the tabs 210 to extend into the apertures 214, as shown in FIG. 2b.

In this example, the tabs 210 have been deformed by splaying them within the apertures 214 such that the tabs 210 contact two opposing internal faces of the second encapsulation member 204 that define the apertures 214. Further details of such tabs are provided below with reference to FIGS. 3a and 3b.

In some examples, the build frame 232 may also have fixing members (not shown) for attaching the fuel cell assembly 200 to a device with which it is associated. For example, the build frame 232 may comprise one or more pegs, or holes for receiving bolts.

Use of the build frame 232 of FIG. 2 can increase the speed of assembly of the fuel cell stack assembly 200.

The build frame 232 can also optionally provide thermal and/or electrical insulation of the fuel cells. The build frame 232 may be made from a plastic. The first and second encapsulation members 202, 204 may be made from stainless steel.

In some examples, the first end plate 206 and/or second end plate 205 may have one or more ports through which a fluid can be communicated to or from the fuel cells. Such a fluid may be a liquid or a gas and can be fuel, air or coolant, for example.

In this example, both of the first and second end plates 206, 205 comprise a preformed element configured with a predetermined curvature such that a surface of the end plate that contacts the fuel cells, which will be referred to as a compression surface, is a convex surface when the preformed element is not under load. This is shown in FIG. 2a.

When the tabs 210 are engaged with the second encapsulation member 204 to apply a load to the fuel cells, flexure of the preformed element between the two ends that are fixed in position relative to the side walls 208 causes the compression surface to become a substantially planar surface. This is shown in FIG. 2b.

In embodiments that use such preformed elements, each end plate 206, 205 is fabricated of a sufficiently stiff, but elastic material such that at the desired compressive loading of the fuel cells during assembly brings each unloaded convex compression face into a substantially planar disposition. The compression of the fuel cells that is maintained by engagement between the tabs 210 and the second encapsulation members 204 results in flexure of each of the end plates 206, 205 such that the compression faces of the respective end plates 206, 205 become both planar, and relatively parallel to one another, thereby imparting a correct uniform pressure on both end faces of the fuel cell stack. The thickness, stiffness and elastic deformability out-of-plane for each of the preformed end plates 206, 205 may be chosen to ensure that planar and uniform pressure is imparted to the fuel cells.

In summary, the expression “preformed” end plates is intended to indicate that the end plates exhibit a predetermined curvature under no load such that they will assume a flat and parallel relationship to one another at the required fuel cell stack assembly compression pressure. The predetermined curvature under no load may be chosen such that it allows for an initial break-in and settling of the stack assembly during assembly and commissioning. In a fuel cell stack assembly, there may be a short period before or during commissioning in which the stack compresses slightly, for example as a result of plastic deformation of layers such as the diffusion layer or various gaskets. The predetermined curvature of the end plates under no load may be configured to accommodate this such that they assume a flat and parallel relationship to one another after commissioning of the fuel cell stack.

Use of one or more such preformed end plates 206, 205 can enable a fuel cell assembly to be constructed to a desired load instead of a set height. As applications for smaller fuel cell stacks become increasingly important, materials with a thinner gauge become particularly advantageous. However, if a fuel cell assembly is built to a set height, an overload may need to be applied to ensure that a sufficient compression force is applied to the fuel cells for all variations of the fuel cell dimensions that are within the tolerances of construction. Such overloading can cause buckling of thin components thereby compromising performance of the fuel cell stack. Therefore, fuel cell assemblies disclosed herein that can be built to a predetermined load instead of a predetermined height can reduce these problems.

FIGS. 3a and 3b illustrate further details of the tab of FIG. 2. FIG. 3a shows an end view of the tab 310′ in an original, un-splayed configuration in an opening in a second end plate 305. FIG. 3b shows an end view of the tab 310″ in a splayed configuration when it is engaged with the second end plate 305.

The tab 310′ has two generally parallel side faces 352′ before it is splayed, as shown in FIG. 3a. A notch 350′ is shown in the top face of the tab 310′. The notch 350′ provides a convenient location for applying a tool to the tab 310′ to splay it. In this example, a tool can be located in the notch 350′ and then forced downwards to enlarge the notch 350′ and splay out the side faces 352. Such an enlarged notch 350″ is shown in FIG. 3b.

As shown in FIG. 3b, the side faces 352″ have been displaced outwards such that they contact and engage the second end plate 305.

In other examples, the side faces 352′ of the tab 310′ may not be parallel prior to splaying. They may instead be at oblique angles to the plane of the fuel cells, for instance an acute angle may be defined between the side faces 352′ of the tab and shoulders of the side wall.

FIG. 3c illustrates a further example of a tab 360 and a corresponding aperture in a second end plate 365. The side face faces 362 of the tab 360 and the internal faces of the second end plate 365 that define the aperture into which the tab 360 is inserted are not parallel to each other when the tab 360 is un-splayed. In this example, the side faces 362 of the tab 360 and the internal faces of the second end plate 365 are parallel when the tab 360 is splayed (as shown in FIG. 3c). Such non-parallel surfaces can be advantageous for increasing the potential contact area between the two components when they are engaged and/or for improving resistance to the expansive force of the one or more fuel cells.

In further examples still, the tab may be twisted in order to deform it such that it engages with the second encapsulation member.

In some examples, a rivet that can be provided integrally as part of the first encapsulation member or second encapsulation member that can be deformed in order to engage the two encapsulation members.

One or more of the examples disclosed herein can simplify known assembly methods for fuel cell stack assemblies, and can be suitable for mass manufacture. This can reduce assembly costs.

Fuel cell stack assemblies described in this document can be smaller than prior art assemblies, due to the locking members and the way they engage with the encapsulation members.

FIG. 4 illustrates a method of assembling a fuel cell stack assembly.

The fuel cell stack assembly referred to in relation to FIG. 4 comprises:
a first encapsulation member comprising a first end plate and two side walls extending transversely from the first end plate;
a second encapsulation member comprising a second end plate; and
one or more fuel cells.

The method begins at step 402 by locating the one or more fuel cells between the first end plate and the second end plate.

At step 404, the method continues by applying an external load to bias the first end plate of the first encapsulation member and the second end plate of the second encapsulation member towards one another, thereby compressing the one or more fuel cells. The one or more fuel cells may be compressed to a desired load.

At step 406, the method comprises deforming the side walls of the first encapsulation member or the second encapsulation member in order for the first encapsulation member to engage with the second encapsulation member. In doing so, a compression force may be applied to the one or more fuel cells.

The fuel cell stack assembly is now assembled, and at step 408, the method concludes by releasing the external load, thereby providing a fuel cell stack assembly that exerts a compression force on the one or more fuel cells and retains the first end plate and the second end plate in a fixed relative position.

It will be appreciated that features described in regard to one example may be combined with features described with regard to another example, unless an intention to the contrary is apparent.

1. A fuel cell stack assembly comprising:
a first encapsulation member comprising a first end plate and two side walls extending transversely from the first end plate;
a second encapsulation member comprising a second end plate; and
one or more fuel cells located between the first end plate and second end plate,
wherein the side walls of the first encapsulation member are, or the second encapsulation member is, deformable in order for the first encapsulation member to engage with the second encapsulation member and retain the first end plate and the second end plate in a fixed relative position.

2. The fuel cell stack assembly of claim 1, wherein the side walls of the first encapsulation member or the second encapsulation member are deformable in order to provide a compression force to the one or more fuel cells.

3. The fuel cell stack assembly of claim 1, wherein the side walls each comprise a projection that extends away from the first end plate, the projection is deformable such that it engages with the second encapsulation member in order to retain the first end plate and the second end plate in a fixed relative position.

4. The fuel cell stack assembly of claim 3, wherein the second encapsulation member comprises two apertures, one for receiving each of the projections.

5. The fuel cell stack assembly of claim 4, wherein the projections are deformable in order to engage with an internal face of the second encapsulation member that defines the aperture.

6. The fuel cell stack assembly of claim 4, wherein the projections are configured to extend into and through the apertures, and are configured to be deformable in order to engage with an external face of the second encapsulation member.

7. The fuel cell stack assembly of claim 1, wherein the first end plate and the second end plate each define a compression surface adjacent to and in compressive relationship with the one or more fuel cells; and
the first end plate and/or the second end plate comprise a preformed element defining the compression surface, the preformed element being configured with a predetermined curvature such that the compression surface is a convex surface when the preformed element is not under a load whereas, under the application of the load to maintain the fuel cells under compression, flexure of the preformed element causes the compression surface to become a substantially planar surface.

8. The fuel cell stack assembly of claim 1, wherein the first end plate and/or the second end plate comprise a port for communicating a fluid to or from the one or more fuel cells.

9. The fuel cell stack assembly of claim 1, further comprising a build frame that is shaped for providing an assembly guide for at least one of: the first encapsulation member; the second encapsulation member; and the one or more fuel cells.

10. The fuel cell stack assembly of claim 9, wherein the assembly guide is orientation specific such that components cannot be inserted into the build frame in an incorrect orientation.

11. The fuel cell stack assembly of claim 10, wherein the assembly guide comprises asymmetrical guide rails, and at least one of the first encapsulation member, the second encapsulation member, and the one or more fuel cells comprises corresponding asymmetrical shoulders.

12. The fuel cell stack assembly of claim 1, wherein both the second encapsulation member and the side walls of the first encapsulation member are deformable.

13. The fuel cell stack assembly of claim 1, wherein the second encapsulation member comprises two side walls extending transversely from the second end plate, and the side walls of the second encapsulation member are deformable in order to engage with the side walls of the first encapsulation member.

14. A method of assembling a fuel cell stack assembly, the fuel cell stack assembly comprising:
a first encapsulation member comprising a first end plate and two side walls extending transversely from the first end plate;
a second encapsulation member comprising a second end plate; and
one or more fuel cells;
the method comprising:
locating the one or more fuel cells between the first end plate and the second end plate;
applying an external load to bias the first end plate of the first encapsulation member and the second end plate of the second encapsulation member towards one another thereby compressing the one or more fuel cells;
deforming the side walls of the first encapsulation member or the second encapsulation member in order for the first encapsulation member to engage with the second encapsulation member; and
releasing the external load, thereby providing a fuel cell stack assembly that exerts a compression force on the one or more fuel cells and retains the first end plate and the second end plate in a fixed relative position.

15. (canceled)

16. (canceled)
